(19) United States
(12) Patent Application Publication
(10) Pub. No.: US 2003/0141245 A1
(43) Pub. Date: Jul. 31, 2003

(54) Method for the treatment of animal waste and products made therefrom

(76) Inventors: Lewis M. Fetterman, Clinton, NC (US); C. Ray Campbell, Raleigh, NC (US)

Correspondence Address: Robert Rosenthal, Suite 200, 5856 Faringdon Place, Raleigh, NC, 27609, US

(21) Appl. No.: 10/071,006

(22) Filed: Feb. 7, 2002

Related U.S. Application Data
(60) Provisional application No. 60/269,780, filed on Feb. 15, 2001.

(51) Int. Cl. C02F 3/02

(52) U.S. Cl. 210/609; 210/620; 210/631; 71/21

(57) ABSTRACT

A method of treating animal waste includes separating the solids by flocculation and dissolved air flow, followed by screening of the solids to separate them from the waste water. The resulting solid portion is used as the basis for manufacturing value-added products including organic fertilizer, liquid fertilizer, soil amendments and soilless media.

### FIELD OF THE INVENTION

This invention relates generally to the field of animal waste treatment and more particularly to a method of collecting and processing swine waste solids and the beneficial products that may be produced therefrom. Additionally, the invention may be adapted to the treatment of other farm, municipal, and industrial waste.

### BACKGROUND OF THE INVENTION

North Carolina currently has approximately 4000 swine production farms that depend on lagoons and spray fields as the means for waste treatment and disposal. The long-term sustainability of this treatment system is questionable. In recent years, concerns have risen over the impact of these systems on groundwater supplies, soil resources, rivers and estuaries. Additionally, concerns have been raised over the odor emanating from these systems, ammonia loss to the atmosphere, animal health and food safety.

The typical swine farm contains six production houses, each of which contains 4360 hogs. There are 2.8 production cycles in each house per year. In the typical operation employing a flush system, approximately 40,000 gallons of liquid waste must be treated and/or disposed of on a daily basis. In addition, at 97% removal, the six house production farm generates approximately 7137 pounds (60% moisture) of solids daily.

The solid and liquid waste described above generates contaminants including, pathogens, heavy metals, nitrogen and phosphorus. Pathogens are of concern because they may contaminate ground water and food supplies. In addition, the combination of pathogens and ammonia levels are of concern to both the health of workers and the animals. Heavy metals are a problem because they may accumulate in soil to toxic levels, thereby rendering them unproductive. Nitrogen and phosphorus may contaminate groundwater, rivers and streams. This in turn, causes algae blooms which can result in fish kills. As a result fishery and tourism are also ultimately affected. Excess nitrate in groundwater is also a human and animal concern.

Currently, the land requirement for swine production farms is large which contributes significantly to the cost of production. This is due to the land required for disposal of waste at agronomic rates on cropland. Many farms have difficulty remaining in compliance with environmental regulations since their land base is limited. Additionally, lagoons used for waste treatment must be cleaned after approximately 15 years of use. The sludge in these lagoons contains high levels of phosphorus, nitrogen and metals. In many cases, the farmland base is not sufficient to receive the sludge at agronomic rates while also receiving the routine waste application. Moreover, there is now evidence that some lagoons are leaking and releasing nitrate into groundwater. Further, lagoons have been known to burst and/or overflow and when their contents is released, catastrophic environmental damage may result. In summary, the current lagoon-based waste treatment system is not sustainable over the long-term future. In addition, the land requirement for nutrient application is also of concern due to the increased capital cost and long-term sustainablity. If phosphorus, zinc and copper accumulation in soil is not controlled and limited, significant environmental impact can occur in that phosphorus is released to surface water and/or groundwater and the land can become sterile due to excess zinc and copper levels. In such cases, the soil will not support plant life. Currently, there is no known acceptable amelioration of such conditions.

In view of the foregoing, it would be of great commercial, economic and environmental value, if a system were devised that minimizes the impact of lagoon-based waste treatment systems on the environment.

It is accordingly an object of the present invention to improve the systems currently in place for the treatment of swine waste.

A primary object of the present invention is to convert the swine waste solids from an unwanted waste to a product of commercial value.

Another primary object of the present invention is the elimination of hog waste lagoons.

Another object of the present invention is to reduce the amount of water used in connection with swine production.

Still another object of the present invention is to significantly reduce the amount of nitrogen, phosphorus and heavy metals released into the environment in connection with swine production.

Still another object of the present invention is to provide organic fertilizers and organic soilless media for use in connection with organic farming.

Yet another object of the present invention is to improve the health of the swine and of the people employed in the swine production houses.

A collateral object of the present invention is to provide a method of treating swine waste that reduces the amount of land necessary to receive the waste.

A related object of the present invention is to provide a method of treating swine waste that significantly reduces the possibility of surface and groundwater contamination.

An allied object of the present invention is to provide a method of treating swine waste that extends the life of the swine production facility.

Another object of the present invention is to provide a method of treating swine waste that reduces the impact on land fills by incorporating other organic waste streams which may otherwise have been dumped into land fills into a useable product.

Another object of the present invention is to provide an alternative to peat used in soilless media.

Finally, an object of the present invention is to reduce the odor associated with swine production.

### SUMMARY OF THE INVENTION

The foregoing objects are accomplished by providing a method of producing swine waste solids suitable for processing into an organic fertilizer, soil amendment, or soilless media from swine waste that includes a solid portion and a liquid portion comprising the steps of separating the solid portion from the liquid portion by mixing a dissolved activated polymer with the waste water to produce a flocculated solid, screening the waste water to remove the flocculated solids from the waste water and composting the solids using vermiculture, aerobic composting, anerobic digestion or other suitable processes; whereby the solid portion may be composted or further processed to produce a useful organic fertilizer, liquid fertilizer, soil amendment or soilless media.

### DETAILED DESCRIPTION OF THE PREFERRED EMBODIMENTS

While the present invention will be described more fully hereinafter in which particular embodiments are described, it is to be understood at the outset that persons skilled in the art may modify the invention herein described while still achieving the favorable results of this invention. Accordingly, the description which follows is to be understood as a broad teaching disclosure directed to persons of skill in the appropriate arts and not as limiting upon the present invention.

For simplicity of description, the specification will refer to ‘swine’ or ‘hog’ sludge, waste water, slurry and the like. However, it will be understood that the present invention can be used to treat human as well as other type of livestock excrement. Other types of municipal and industrial waste are also encompassed by the present invention. With respect to the technology described herein, swine waste has the smallest solid particle size and is therefore among the most difficult to treat. It should therefore generally be considered a worst case.

It was the goal of the inventors to devise a method of treating swine waste that would render the waste at worst ecologically harmless and in the best case, would yield economically useful and ecologically beneficial by-products that could be used outside the production area.

With the foregoing in mind, according to the present invention, the swine production house is cleaned with a water flush. The contaminated waste water is then removed from the swine house to the treatment facility located nearby. The solid separation phase begins by activating a polyacrylamide (PAM) polymer. The activated PAM polymer is then mixed with the wastewater in an ionic transfer reactor module. This mixture is then passed through a rotating screen with 0.200 mm openings to separate the flocculated solids. The flocculated solids remain above the screen and the water passes through the openings. The flocculated solids are then directed onto a vibrating screen to further dewater the manure and a small dissolved air flotation unit operates to further separate residual solids in the liquid stream before exiting to the water treatment section. The solids may then be further processed to achieve a preselected moisture level compatible with subsequent processing (i.e., composting) by passing them over a belt filter. In addition, the solids may be processed using other suitable equipment, known to those familiar with the art, to achieve the desired moisture level.

A mixing tank for 50,000 gallons receives the wastewater from the production houses and homogenizes the liquid manure for consistent PAM treatment. This process can be run either continuous-flow or batch. The separation module is contained in a 6 m×6 m house with two floors. The flocculated liquid is passed over a screen and the solids are collected outside the house and are transported to the composting/processing facility, as will be described in greater detail hereinbelow. Additional efficiency in solids removal is attained with a dissolved air flotation (DAF) unit wherein the skimmed solids are returned to the mixing tank for subsequent separation. The unit employs cationic PAM with 20% charge density for optimum performance. A unit such as described above is commercially available from SELCO Network, M. C. of Castellon, Spain.

At this point in the process, approximately 75% to 80% of the nutrients (nitrogen, phosphorus, copper, zinc) have been removed from the swine wastewater. As such, the liquid portion can then be stored in a tank or existing lagoon for subsequent use in re-filling the waste collection pits in the hog houses or fertilizing crops. This liquid contains almost no organic nitrogen, approximately 400 mg/L inorganic nitrogen, 50 mg/L phosphorus and traces of copper and zinc. If desired, the liquid can be further processed to reduce nitrogen and phosphorus to insignificant levels and kill pathogens.

After separation, solids are transported to a composting/soil blending facility for processing and manufacturing. The composting process stabilizes the solids, kills pathogens, reduces plant toxins, and converts the solids to a by-product that can be used as a soil amendment, fertilizer, or component of a soil-less media. Procedures such as water extraction and anaerobic digestion can also be used to produce liquid fertilizer.

Solids can be processed using vermicomposting, anaerobic digerstion, and/or aerobic composting. For vermicimposting, solids are aged 1-3 weeks before feeding. Red worms in this system are selected and cultured for their tolerance to swine solids. Swine solids are fed to worms in 4-5 ft. wide beds until the castings accumulate to approximately 1.5-2 ft. high. Worms are then collected from the beds and solids are removed for screening and blending to formulate special soil mixes. Anaerobic digestion takes place in a large vessel designed to move the solids from one end to the other in approximately 15 days. Microbes are selected for their performance at high temperatures. Methane gas is removed from the vessel and used as an energy source. Solids removed from the digester are pressed to remover water and either stored or further processed in aerobic systems for later use in manufacturing soil amendment, fertilizer, and/or soil-less media. Ingredients of the feeding stock are adjusted depending on availability, gas yield and compost quality. Each of these processes result in compost with different characteristics and macro-flora populations. They can be blended later to form working substrates to make fertilizer, soil amendment, and soil-less media. Substrate from vermicompost and anaerobic systems may also be further processed using aerobic composting to reduce plant toxins and/or pathogens. Final products may also be heat-treated to further reduce pathogens.

The composting formulation will differ depending on the intended use of the solids and available carbon sources. For general soil amendment production, swine solids can be blended with a number of carbon sources including leaves or lawn waste, tobacco processing trash, cotton gin trash and other crop residues such as hay, soft or hardwood bark, sawdust and vegetable processing waste. The proportion of these materials and water added to the compost mix depends on the carbon and nitrogen concentrations, and moisture content of the raw materials. The compost mix has a carbon:nitrogen ratio of 20-30 and a moisture content of 60%. The mix is composted for 4-6 weeks with aeration and additional water as needed to facilitate the process. Compost temperatures are monitored and maintained at 55 C. or higher for 3 days in a within-vessel or static-pile system and 15 days for a windrow system. If in windows, the compost is turned a minimum of 5 times during the high temperature period. The resulting product is cured 4-6 weeks during which time moisture is stabilized at approximately 60%. If the compost is to be used as a soil amendment, it is screened to a one-half inch or other suitable sizes and bagged or marketed in bulk.

For making an organic fertilizer, swine solids are composted using a bulking agent such as wood chips to achieve acceptable aeration. Moisture is added as needed to facilitate the composting process. The blend of swine solids and wood chips is composted for 4-6 weeks and is turned a minimum of 5 times during the high temperature period. After a 4-6 week curing period, the product is screened to one-forth inch to remove wood chips and bagged or stored in bulk for distribution. The screened material may also be fortified with nutrients such as nitrogen, phosphorus and/or potassium to improve fertilizer value and thereafter pelletized before bagging or bulk delivery.

For soilless media production, compost ingredients are strictly controlled to produce the desired product. Softwood bark, coir fiber and cotton gin trash are used alone or in combination to produce an amendment that can be used in soilless mixes targeted for use in container and greenhouse plant production industries. For the containerized nursery industry, the composted product is mixed with aged pine bark to achieve a final ratio of approximately 15-20% swine solids by volume. The mixed product is screened to ⅜ inch size and bagged or sold in bulk. In some cases, the product may be screened to ½ inch size to enhance aeration and drainage. No fertilizers or liming materials need to be added to the soilless mix. It will be noted that clay or a similar material (such as kaolinite) may be added at a rate of 0.5% to 1.00% by volume to “tie up” a portion of the available phosphorus, provide additional available iron in the mix and safen the mix from phosphorus loss and the resulting environmental impact. More specifically, the addition of clay (such as is found in certain types of unwashed sand) ties up the phosphorus and releases iron, thereby improving plant growth and limiting environmental impact by reducing the amount of soluble phosphorus released as the soil mix drains. The swine solids adjust pH to the desired range and provide adequate fertilizer charge for initial growth. In some cases the slow release organic fertilizer charge may last the majority of the growing season.

Soilless media for various greenhouse production systems are made using either swine solids composted with wood chips which serve as a bulking agent or softwood bark and cotton gin trash used alone or in combination. Other carbon sources may also be used as deemed appropriate. After 4-6 weeks composting and 4-6 weeks curing, the resulting mix is screened to ¼ inch size and stored for blending.

Contents of the soilless media blend will depend on the intended use of the final product. Other amendments including peat, coir fiber, vermiculite, and Perlite are added in preselected proportions to achieve the desired results. Certain grades of amendments like vermiculite may also alter the final product. In general, the composted swine solids serve as a substitute for peat while also producing an adequate nutrient charge and adjusting pH of the media to the desired range. A variety of soilless media can be manufactured with swine solids and should not be limited to the following examples:

### SOILLESS MEDIA BLENDS FOR TRANSPLANT OR SEEDLING PRODUCTION

Soilless media for use in transplant or seedling production such as those used in float or overhead watering systems may be made using swine solids composted only with a bulking agent. After curing, the product is screened to ¼th inch size and stored for manufacturing. The screened by-product is mixed at an approximate ratio of 80:20 by volume of composted swine solids and either Perlite or horticultural grade Vermiculite. Results of replicated comparisons of these mixes with standard commercial media indicate that they perform equal or superior to peat-based mixes currently on the market. Tobacco seedlings, for example, were produced to transplant size (4 inch stem length from root to top node) in 43 days using composted swine solids at an 80:20 ratio with horticultural grade vermiculite. Plants grown in a well-known commercial mix were only 1.2 inches in stem length at the end of the same production period. Germination was similar for the two mixes. Nutrient characteristics of the two mixes are shown below:

| | | | | CEC | | Ac | | | |
|---|---|---|---|---|---|---|---|---|---|
| SOIL | MAKE- | HM | W/V | meq/ | BS | meq/ | | P—I | K—I |
| MIX | UP | % | gm/cm3 | 100 cm3 | % | 100 cm3 | pH | index | index |
| PSS | 6SS 2P | 0.23 | 0.3 | 24.2 | 88 | 3.1 | 5.2 | 1499 | 161 |
| WSS | 8SS 2V | 0.18 | 0.29 | 20.1 | 88 | 2.6 | 5.2 | 1142 | 90 |

| | | | | | | | | | Na |
|---|---|---|---|---|---|---|---|---|---|
| SOIL | Ca | Mg | Mn—Al | Zn—Al | Cu—I | S—I | SS—I | NO3—N | meq/ |
| MIX | % | % | index | index | index | index | index | mg/dm3 | 100 cm3 |
| PSS | 70 | 14 | 97 | 1700 | 138 | 320 | 121 | 344 | 0.4 |
| WSS | 67 | 18 | 90 | 1248 | 146 | 262 | 155 | 200 | 0.2 |

SS = Swine Solids
P = Perlite
V = Vermiculite

Due to the nutrient charge provided by the amendment according to the present invention, transplants can be grown with the addition of only 75 mg/L of nitrogen added to the float solution or fed through overhead irrigation during the last three weeks of plant production. In organic production systems, a water extract of the compost swine solid produces a liquid fertilizer that can be added to the float solution to finish the plant production season.

The soilless mixes can also be used for general plant production.

### SOILLESS MEDIA BLENDS FOR GENERAL PLANT PRODUCTION

Soilless media blends for general plant production include swine solids composted with certain ratios of softwood bark and/or cotton gin trash or wood chips. This compost can serve as a replacement for peat and provides a nutrient charge. Mixes of this type have proven useful in growing pansy and other bedding plants. Pansy is used as an indicator of useability of the media due to the sensitive growing requirements of this species. Studies indicate increased root and top growth of our mixes as compared to the conventional peat-based mixes. Examples of soilless media mixes manufactured from swine solids include, but are not limited to the following described hereinbelow. The formulations are given on a volume basis indicating the sequence of combinations necessary to manufacture the mix.

PN26 - Suggested for growing crops such as southern pine seedlings that require relatively low fertility, superior aeration, and excellent drainage.

Formulation: 0.95[0.075(0.6 C1+0.4 CF)+0.25 P]+0.5 S

Where: C1=Composted Mixture of 2 SS:1 Pine Bark

CF=Coir Fiber (Coconut Husk or Fiber)

P=Perlite

S=Unwashed Coarse Sand

SS=Swine Solids

PN26 is manufactured by composting 2 parts (by volume) Swine Solids with 1 part (by volume) of aged pine bark. After complete composting, aging, and screenig to 0.25 inch, 6 parts of the screened product (c1) are mixed with 4 parts Coir Fiber (CF). After through mixing, 3 parts of the resulting mixture are combined with 1 part Perlite. Nine and one half (9.5) parts of this product are then combined with 0.5 part Sand to form the final mixture.

8B - Suggested for general plant production:

Formulation: 0.6 C1+0.2 CF+0.2V

Where: C1=Composted Mixture of 2 SS: 1 Pine Bark

CF=Coir Fiber (Coconut Husk or Fiber)

V=Vermiculite

SS=Swine Solids

8B is manufactured by composting 2 parts (by volume) Swine Solids with 1 part (by volume) Pine Bark. After complete composting, aging and screening to 0.25 inch, 6 parts of the screened product C1 are mixed with 2 parts Coir Fiber, and 2 parts Vermiculite.

PN9 - Suggested for general plant production:

Formulation: 0.6 C2+0.3 P+0.1 S

Where: C2=Composted Mixture of 1 SS: 1 Pine Bark

P=Perlite

SS=Swine Solids

S=Unwashed Coarse Sand

PN9 is manufactured by composting 1 part (by volume) Swine Solids with 1 part Pine Bark. After complete composting, aging, and screening to 0.25 inch, 6 parts of the screened product (C2) are mixed with 3 parts Perlite and 1 part Sand.

6A - Suggested for General plant production:

Formulation: 0.5 C3+0.5 CF

Where: C3=Composted Swine Solids

CF=Coir Fiber (Coconut Husk or Fiber)

SS=Swine Solids

Formulation 6A is manufactured by composting Swine Solids with wood chips for aeration. After complete composting, aging, and screening to 0.25 inch, 5 parts (by volume) of the screened product (C3) are mixed with 5 parts Coir Fiber (CF).

AZ5 - Suggested for azaleas, camellias, and other ornamentals.

Formulation: 0.14 S+0.86 C4

Where: C4=Composted Mixture of 1 part SS to 3 parts Pine Bark

SS=Swine Solids

S=Unwashed Coarse Sand

AZ5 is manufactured by composting 1 part (by volume) Swine Solids with 3 parts Pine Bark. After complete composting, aging, and screening to 0.5 inch, 6 parts of the screened product (C4) are mixed with 1 part Sand.

Nutrient concentrations in these mixes are shown in the table below:

| | | | CEC | | Ac | | | | | | | | | | | | Na |
|---|---|---|---|---|---|---|---|---|---|---|---|---|---|---|---|---|---|
| SOIL | HM | W/V | meq/ | BS | meq/ | | P—I | K—I | Ca | Mg | Mn—Al | Zn—Al | Cu—I | S—I | SS—I | NO3—N | meq/ |
| MIX | % | cm/cm3 | 100 cm3 | % | 100 cm3 | pH | index | index | % | % | index | index | index | index | index | mg/dm3 | 100 cm3 |
| PN26 | 0.22 | 0.33 | 19.2 | 85 | 2.8 | 5.1 | 1093 | 516 | 56 | 15 | 92 | 1116 | 75 | 202 | 230 | 105 | 0.6 |
| PN9 | 0.27 | 0.45 | 24.3 | 87 | 3.2 | 5.2 | 1225 | 190 | 67 | 17 | 124 | 1578 | 126 | 192 | 158 | 120 | 0.8 |
| 6A | 0.36 | 0.24 | 18.2 | 90 | 1.8 | [symbol] | 949 | 667 | 61 | 11 | 80 | 12448 | 71 | 156 | 181 | 151 | 0.6 |
| 8B | 0.18 | 0.26 | 19.8 | 88 | 2.4 | 5 | 1186 | 326 | 64 | 16 | 100 | 1086 | 115 | 148 | 129 | 120 | 0.4 |

In tests that were conducted that compared pansy bedding plants grown under standard nursery conditions in formulation 6A and a standard commercial mix (Metro 360), plants in mix 6A exhibited greater vigor and were larger than those grown in the standard commercial mix. Comparisons of root and top growth dry weights halfway through the growing season indicated equal or higher dry matter accumulation for mix 6A as shown below:

| | TOP GROWTH | ROOT GROWTH |
|---|---|---|
| TREATMENT | grms | grms |
| 6A | 5.54 | 2.00 |
| M360 | 5.45 | 1.94 |

The present invention, of course may be carried out in other specific ways than those set forth herein without departing from the spirit and essential characteristics of the invention. The present invention is therefore, to be considered in all respects as illustrative and not restrictive, and all changes coming within the meaning and range of the appended claims are intended to be embraced therein.

That which is claimed is:

1. A raw material of swine solids suitable for processing into an organic fertilizer, soil amendment or soilless media, prepared by a process consisting of the steps of:
mixing a dissolved activated polymer with swine waste water to produce a flocculated solid;
screening the swine waste water to remove the flocculated solids from the swine waste water;
separating the flocculated solid from the liquid portion and passing the solid portion through a belt filter press to reduce the moisture content to a preselected level,
whereby the flocculated solid is processed to produce an organic fertilizer, soil amendment or soilless media and the treated liquid is substantially free from solids, odor, and nutrients.

2. The raw material of swine solids according to claim 1 wherein the step of screening further includes the steps of passing the flocculated solid through a rotating screen filter to remove a first group of flocculated solids; and
passing the flocculated solids through a vibrating screen and a roller press to further dewater the flocculated solids.

3. The raw material of swine solids according to claim 2 wherein the flocculated solids have a moisture content of between about 40% to about 70%.

4. The raw material according to claim 3 further including the step of composting the flocculated solids from the composting methods selected from the group consisting of vermicomposting, anaerobic digestion and aerobic composting.

5. A raw material of swine solids from swine waste water of the type including a solid portion and a liquid portion, characterized by its uniformity and which substantially concentrates the nutrients in the solid portion and removes them from the liquid portion, prepared by a process consisting of:
separating the solid portion from the liquid portion,
composting the separated solid portion,
whereby the resulting composted solid portion may be mixed with other carbon sources and used to produce a fertilizer, soil amendment or soilless media and the treated liquid is substantially free from solids, odor and nutrients.

6. A method of producing a soil amendment characterized by improved nutrient bioavailability comprising the steps of:
blending swine solids with a carbon source to form a swine solid mix;
composting the swine solid mix for about 4 to 6 weeks;
curing the swine solid mix for about 4 to 6 weeks;
whereby a stabilized soil amendment is formed that is substantially free of pathogens.

7. The method according to claim 6 wherein the carbon source is selected from the group consisting of leaves, lawn waste, tobacco processing trash, cotton gin trash, hay, softwood bark, hardwood bark, sawdust or vegetable waste.

8. The method according to claim 7 wherein the carbon-nitrogen ratio is about 20-30 and the moisture content is about 60%.

9. The method according to claim 7 wherein the step of composting further includes the step of aeration and adding water to facilitate composting.

10. The method according to claim 7 further including the step of adding up to 2.0% by volume of clay;
whereby phosphorus is tied up and iron availability is increased.

11. A soilless media having improved nutrient bioavailability and comprising:
a mixture of composted hog waste solids and a composted carbon source having a moisture content of between about 40% and about 70%.

12. A soilless media according to claim 11 wherein the carbon source is selected from the group consisting of leaves, lawn waste, tobacco processing trash, cotton gin trash, hay, soft wood bark, hardwood bark, sawdust and vegetable waste.

13. A soilless media according to claim 11 further comprising:
40% to 60% by volume composted swine solids; and
40% to 60% by volume Coir fiber.

14. A soilless media according to claim 10 further comprising:
10% to 18% by volume unwashed coarse sand; and
75% to 90% by volume of a composted mixture of 1 part swine solids to 3 parts pine bark.

15. A soilless media according to claim 10 further comprising:
50% to 70% by volume of a composted mixture of one part swine solid and 1 part pine bark;
20% to 40% by volume of Perlite;
5% to 15% by volume of sand.

16. A soilless media according to claim 10 further comprising:
50% to 70% by volume of a composted mixture of two parts swine solids and one part pine bark;
10% to 30% by volume Coir fiber; and
10% to 30% by volume of Vermiculite.

17. A soilless media prepared by a process consisting of:
composting a mixture of swine solids and pine bark to produce a composted mixture;
mixing the composted mixture with Coir fiber to produce a fibrous mixture; and
mixing sand with the fibrous mixture;
whereby a stabilized soilless media is formed that is substantially free of pathogens and has enhanced nutrient bioavailability.

18. The soilless media according to claim 17 further including the step of:
adding clay to the sand and fibrous mixture;
whereby phosphorus is tied up and iron is made available for plant growth.

19. A soilless media prepared by the process consisting of:
composting a mixture of about 2 parts swine solids to about 1 part pine bark to produce a composted mixture;
adding approximately one third as much Coir fiber to the composted mixture to produce a fibrous mixture;
adding approximately one third as much Vermiculite to the fibrous mixture;
whereby a stabilized soilless media is formed that is substantially free of pathogens and has enhanced nutrient bioavailability.

20. The soilless media prepared by the process according to claim 11 further including the step of adding clay to the soilless media.
